(19) United States
(12) Patent Application Publication
(10) Pub. No.: US 2014/0223185 A1
(43) Pub. Date: Aug. 7, 2014

(54) ACTION VERIFICATION METHODS AND SYSTEMS

(71) Applicants: Jason Frederick Bender, Glen Osmond (AU); James Evan Lenon, Unley (AU)

(72) Inventors: Jason Frederick Bender, Glen Osmond (AU); James Evan Lenon, Unley (AU)

(73) Assignee: Emue Holdings Pty Ltd., Melbourne, Victoria (AU)

(21) Appl. No.: 14/235,008

(22) PCT Filed: Jul. 24, 2012
(86) PCT No.: PCT/AU2012/000875

§ 371 Date: Mar. 28, 2014

Related U.S. Application Data
(60) Provisional application No. 61/511,493, filed on Jul. 25, 2011.

(30) Foreign Application Priority Data
Jul. 25, 2011 (AU) 2011902947

(51) Int. Cl. H04L 29/06; H04L 9/32

(52) U.S. Cl. CPC H04L 63/0853; H04L 9/3247
USPC 713/176

(57) ABSTRACT

The present invention relates to a method of verifying that an action is authorised by a user, including receiving a request from a first user device to a remote service via a first communications channel to perform an action at the remote service, receiving a user identifier from the first user device via the first communications channel, the user identifier identifying the user, associating the user identifier with data relating to the requested action, communicating the data to a second user device associated with the same user identifier via a second communications channel, receiving a user verification code associated with the user identifier, and determining if the user verification code includes the data, which is digitally signed using a code generation algorithm based on at least a key associated with the user identifier, the digitally signed data verifying that the action is authorised by the user.

This application is associated with and claims the benefit of the filing and priority dates of the Australian provisional patent application no. 2011902943 and the U.S. provisional patent application No. 61/511,493; the contents of which as filed are incorporated herein by reference in its entirety.

### FIELD OF THE INVENTION

The present invention generally relates to electronic authorisation methods, systems and devices for verifying that actions at a remote service that appear to be requested by a user are actually authorised by the user.

### BACKGROUND OF THE INVENTION

In electronic authorisation systems, users are required to authenticate themselves to a remote service before they are granted access the service, such as Internet banking, on-line shopping, an automatic teller machine, share trading, bill payment, electronic funds, a telecommunications service, access to a room or vehicle. The proof of authorisation may be in the form of a password or PIN that the user must enter before they are allowed access.

Electronic authorisation systems may be subject to “man in the middle” attacks, where an attacker can place themself between the user's computer and the remote service and intercept communications between the user and the remote service. The attacker can then relay communications to the user and the remote service, impersonating the user to the remote service, and impersonating the remote service to the user.

Another type of attack on electronic authorisation systems is keystroke logging, where the attacker tracks the keys on a keyboard pressed by a user. For example, the key logger may use software programmed to snoop on the user's keystrokes, or a hidden camera to spy on the user. The attacker can thus view the user's username and password or PIN, and use these details to covertly obtain authorisation to access a remote service.

Yet another threat to electronic authorisation systems is “man in the browser” attacks, where an attacker gains access to the user's computer and is able to modify what is viewed by the user, and what is sent from the user's computer to a remote service. For example, a user making an Internet banking transaction may be shown correct payment information corresponding to an amount and destination account typed in using the keyboard, but a different payment amount and destination account may be sent to the bank.

It would be desirable to provide a method for verifying that actions are authorised by a user which addresses one or more of the potential attacks described above.

The above discussion of background art is included to explain the context of the present invention. It is not to be taken as an admission that any of the documents or other material referred to was published, known or part of the common general knowledge at the priority date of any one of the claims of this specification.

### SUMMARY OF THE INVENTION

In an aspect, the present invention provides a method of verifying that an action is authorised by a user, including: receiving a request from a first user device to a remote service via a first communications channel to perform an action at the remote service, receiving a user identifier from the first user device via the first communications channel, the user identifier identifying the user, associating the user identifier with data relating to the requested action, communicating the data to a second user device associated with the same user identifier via a second communications channel, receiving a user verification code associated with the user identifier, and determining if the user verification code includes the data, which digitally signed using a code generation algorithm based on at least a key associated with the user identifier, the digitally signed data verifying that the action is authorised by the user.

In an aspect, the present invention also provides a method of a user authorising an action at a remote service, including: communicating a request from a first user device to a remote service via a first communications channel to perform an action at the remote service, communicating a user identifier from the first user device to the remote service via the first communications channel, the user identifier identifying the user, receiving data relating to the requested action at a second user device associated with the same user identifier via a second communications channel, executing a code generation algorithm on the second user device to digitally sign the data, thereby generating a user verification code, the code generation algorithm being based on at least a key associated with the user identifier, communicating the generated user verification code to the remote service, the user verification code enabling the remote service to verify that the action is authorised by the user.

In an aspect, the present invention further provides a method of verifying that an action is authorised by a user, including: receiving a request from a first user device to a remote service via a first communications channel to perform an action at the remote service, receiving a user identifier from the first user device via the first communications channel, the user identifier identifying the user, associating the user identifier with data relating to the requested action, communicating the data to a second user device associated with the same user identifier via a second communications channel, executing a code generation algorithm on the second user device to digitally sign the data, thereby generating a user verification code, the code generation algorithm being based on at least a key associated with the user identifier, communicating the user verification code to the remote service, the remote service determining if the user verification code includes the data, which is digitally signed using at least the key associated with the user identifier, the digitally signed data verifying that the action is authorised by the user.

The digitally signed data provides a verification that the requested action is authorised by the user, because in order to sign the data, the user must have access to the key associated with the user identifier. This may make it more difficult for a “man in the middle” attacker to impersonate the user. If the attacker attempted to request an action be performed at the remote service, the attacker would also need to sign data relating to that requested action for the action to be authorised. To produce a valid digital signature, the attacker would need to know the key associated with the user identifier.

The fact that the data is sent to a second user device that is different to the first user device that requested the action, via a second communications channel that is different to the first communications channel used in the initial request also makes it more difficult for a “man in the middle” to attack the system. An attacker snooping on keystrokes made by the user and communicated via the first communications channel would need to also intercept communications on the second communications channel in order to impersonate the user and perform the action.

The first user device and second user device may be any electronic device, and may be the same or different types of device. Examples of devices include a desktop computer, portable computer, tablet, personal digital assistant (PDA), mobile or cellular phone, smart phone, smart card or credit card. In one embodiment, the first user device is a computer and the second user device is a smart phone.

Where the second user device is a smart phone or other portable device, this may increase the security of the system, as a portable device is more difficult to attack than a device that is physically located at the same location for an extended period of time. Also, a smart phone may provide a more controlled environment, which is more difficult for a malicious third party to infect. Using a mobile phone network rather than the internet to communicate the data, also increases the difficulty for an attacker to intercept the data, as a mobile network is a private network that is structured and maintained, whereas the internet is a public network containing many pathways.

The key may be stored on the second user device and the code generation algorithm may be executed on the second user device. This provides additional security, as it makes it more difficult for a “man in the middle” attacker to determine the key associated with the user identifier. The attacker would need to compromise both the first and second user devices.

The key associated with the user identifier may be a private key in a public key infrastructure (PKI) arrangement. In this case, the remote service may use a public key associated with the user identifier to verify that the data was digitally signed using the user's private key. Alternatively, the key may be a shared secret key, known to the user and the remote service. It will be appreciated that many different types of digital signatures could be used, as would be understood by the skilled person.

The requested action may be any electronic action, such as logging into an account, purchasing items online, transferring money from one account to another, updating details in an account such as contact details or shipping address or any other action.

The data relating to the action may be any word, phrase, term, number, symbol, digit, bit sequence or combination thereof. The data may be intelligible to the user, or it may be unintelligible. It may be generated by the remote service or by the first user device. The data may describe the action, it may be an identifier associated with the action, it may relate to the means of requesting the action or have any other association with the requested action.

In one example, the data relating to the action includes a session identifier associated with an application on the first user device used to request performance of the action. For example, the application may be a web browser or mobile phone app. This embodiment may enable the remote service to confirm that the application used to request the action is being used by the actual user associated with the user identifier. If a “man in the middle” attacker logged the user's key strokes and attempted to impersonate the user, the application used by the attacker would be allocated a different session identifier by the remote service. Even if the attacker discovered a user verification code transmitted from the user to the remote service, the attacker would not be able to use this code to request the action using a different application.

The session identifier may be allocated to the first user device by the remote service, for example, when the application on the first user device first accesses the remote service. It may be sent to the first user device via a cookie. The session identifier may be any piece of data used to identify a session of interaction between the first user device and the remote service. It may be an n-digit number, a string of data or any combination of numbers, digits, characters and/or symbols. It could be a randomly generated piece of data, or it may be metadata or information about the first user device. In one example, the session identifier may be a HTTP session ID associated with a browser on the first user device.

The data relating to the action may alternatively or additionally include information about the action. The method may include before executing the code generation algorithm, displaying the data on the second user device for the user to check. The user may thus have the opportunity to check the data before authorising the action. This addresses the “man in the browser” attack, where an attacker takes control of the user's computer, and may request an action in the background, while displaying to the user that the requested action corresponds to what the user has typed in. Because information about the action is communicated to the second user device, the user may check that the information corresponds to what they have typed in, before signing the data to signify their authorisation.

The action may relate to a purchase of one or more items, and the data relating to the action may include information about the one or more items. For example, the user may use the first device to request a purchase of a 6 pack of cola for $10. Data such as “6 pack of cola—$10” may be sent to the second user device for the user's confirmation. If the user instead receives data such as “a BMW convertible—$50,000”, then the user would be alerted to the attack, and could cancel the action.

For further security, the code generation algorithm for digitally signing the data may be based on user entered information as well as the key associated with the user identifier. The user entered information may be a personal identification number (PIN) or a password, it may be biometric information such as a fingerprint, voice, face or eye recognition, or any other information. The user entered information may be entered using any input device. For example, where the code generation algorithm is executed at the second user device, the method may include receiving information entered by the user at the second user device before executing the code generation algorithm, wherein the code generation algorithm is based on the user entered information as well as the key associated with the user identifier.

The method may further include: associating the user identifier with additional data relating to the action, communicating the additional data to the second user device via the second communications channel, receiving an additional user verification code associated with the user identifier, and determining if the additional user verification code includes the additional data, digitally signed using at least the key associated with the user identifier. The additional data may be any type of data as described above. For example, the data may be a session identifier and the additional data may be information about the action. These two pieces of data may accordingly be signed separately by the user. Of course, it will be appreciated that the data may be a combination of multiple pieces of information or identifiers, signed together using an appropriate code generation algorithm.

The user verification code associated with the user identifier may be received from the first user device via the first communications channel. The method may thus include, after executing the code generation algorithm on the second user device, receiving the user verification code into the first user device, wherein the first user device communicates the generated user verification code to the remote service.

The user verification code may be transferred from the second device to the first device by any means. For example, the user may physically enter the user verification code into the first device using a user input on the first device, the second device may wirelessly transmit the code to the first device using any wireless protocol, or the first and second devices may be physically connected using e.g. a cable or other connector and the code may be transferred via the cable.

The method may further include the remote service receiving from the first user device the data together with the user verification code, wherein determining if the user verification code includes the data, digitally signed includes determining if the digitally signed data matches the data received with the user verification code. For example, where the data is the first user device session identifier as described above, the user verification code (digitally signed session identifier) may be entered into a webpage provided by the remote service, and transmitted to the remote service together with the session identifier. The session identifier may be transmitted as part of a cookie associated with the application. If the user verification code matches the session identifier transmitted with the cookie, then the remote service can have more confidence that the user is actually using the application.

Instead of the first user device communicating the generated user verification code, the second user device may communicate the generated user verification code to the remote service. The user verification code may be received from the second user device via the second communications channel. Where the data is intelligible, it may be displayed on the second user device for the user to check before the code generation algorithm is executed and the user verification code communicated to the remote service. Alternatively, the process may take place automatically without any user interaction. As another alternative, the user may enter a PIN, password or biometric data into the second device to activate execution of the code generation algorithm and communication of the user verification code.

The first and second communications channel used to communicate with the first and second user devices may be the same type of communications channel or different types of communications channels. Types of communications channels that may be used include internet, mobile phone network, wireless, hard wired or any other channel for communicating between two end points. In one embodiment, the first communications channel may be an internet communications channel and the second communications channel may be a mobile phone network communications channel. Using different types of communications channels may further add, security to the system, as a “man in the middle” attacker would need to snoop on two different communications channels or media.

Communicating the data to the second user device via the second communications channel may be done automatically, after receiving the request from the first user device, or it may be in response to a request received from the second user device. The method may accordingly include, before the remote service communicates the data to the second user device, the remote service receiving a request from the second user device via the second communications channel to communicate the data. Correspondingly, on the second user device side, before receiving data relating to the requested action at the second user device, the method may include the second user device communicating a request to communicate the data to the remote service via the second communications channel. Thus, the user may initiate the communication of the data through the second user device. For example, after using the first user device to request the action, the first user device may display a webpage to the user requesting them to enter a user verification code. The user may then use the second user device to request the data and afterwards generate the user verification code by using the code generation algorithm to digitally sign the data.

The request from the second user device may include a user authentication code, the user authentication code enabling the remote service to authenticate the user. The method may further include determining whether the user authentication code authenticates the user, and communicating the data to the second user device only if the user authentication code authenticates the user. The user authentication code may be generated using the same code generation algorithm and key as are used to generate the user verification code. Alternatively, the user authentication code could be a password or biometric information associated with the user identifier. Any electronic authentication method could be used to authenticate the user.

Alternatively or additionally, the request from the second user device to the remote service may include information relating to the second user device. The method may then further include determining a risk score based on the information relating to the second user device.

Where the second user device is a mobile phone or smart phone, the information relating to the second user device may include information such as handset type, IMEI number, IMSI number, phone number, handset serial number, location of the handset, language settings, browser/application settings, metadata and/or any other information that may be obtained from the smart phone.

The risk score may be a number or a percentage which indicates a confidence that the user is who they purport to be. The remote service may use the risk score to verify that the action is authorised. Based on the risk score, the remote service may limit the transactions that the user may perform. For example, where the remote service is a bank, the bank may limit the amount that the user may transfer, the number of transfers they may make, or the bank may require additional authentication information to be provided before allowing a transfer.

The method may further include the remote service communicating a remote service authentication code to the second user device via the second communications network, the remote service authentication code enabling the user to authenticate the remote service. On the user side, the method may include before executing the code generation algorithm, receiving a remote service authentication code from the remote service, determining whether the remote service authentication code authenticates the remote service, and executing the code generation algorithm and communicating the generated user verification code to the remote service only if the remote service authentication code authenticates the remote service.

Again, the remote service authentication code may be a set password or a code generated using any electronic authorisation system. The remote service authentication code may be generated using a shared secret key, using the same code generation algorithm as used to digitally sign the data. It will be appreciated that many different types of authentication methods could be used, as would be understood by the skilled person. The authentication of the remote service may take place before or after the authentication of the user. Mutual authentication methods that may be used are described in patent application PCT/AU2005/001923 to the present applicant, the contents of which are hereby incorporated by reference.

The method may further include: if the remote service authentication code authenticates the remote service, providing an indication to the user on the second user device. The indication may be any display, sound, light or lack thereof that indicates to the user that the remote service is authentic. For example, prompting the user to enter a PIN into the second device may indicate that the remote service has been authenticated.

In an aspect, the present invention also provides software for use with a remote service system, a first user device and/or a second user device, the respective system or device including a processor and memory for storing the software, the software including a series of instructions executable by the processor to carry out the method in accordance with any one of the embodiments described above.

In an aspect, the invention also extends to a computer readable media containing the software, and a remote service system including a processor, a memory and software resident in memory accessible to the processor, the software executable by the processor to carry out the method in accordance with any one of the embodiments described above.

### BRIEF DESCRIPTION OF THE DRAWINGS

Embodiments of the present invention will now be described, by way of example only, with reference to the accompanying drawings. It is to be understood that the particularity of the drawings does not supersede the generality of the preceding description of the invention.

FIG. 1 is a schematic diagram of an example network including an authentication system, a remote service server and first and second user devices according to an embodiment of the invention.

FIG. 2 is a lower level block diagram of an authentication system of FIG. 1.

FIG. 3 is a lower level block diagram of a user device of FIG. 1.

FIG. 4 is a flow chart of a method of verifying that an action is authorised by a user.

FIG. 5 is a flow chart of a method of verifying that a user is authorised to log into an online bank account according to an embodiment of the invention.

FIG. 6 is a flow chart of a method of verifying that a purchase of items online is authorised according to another embodiment of the invention.

### DETAILED DESCRIPTION

### Example of a Network

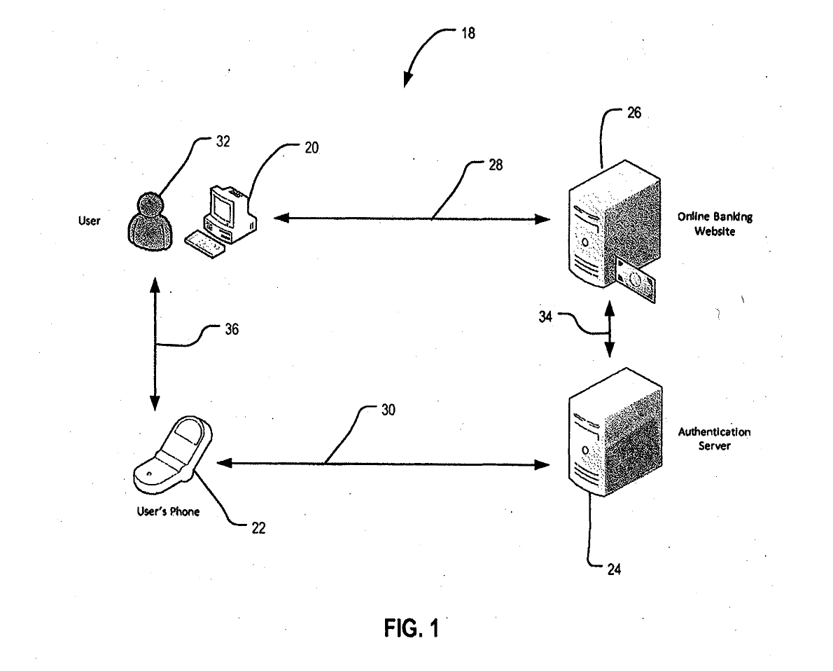

Embodiments of the present invention may be realised over a network, an example of which is shown in FIG. 1. The network 18 shown in FIG. 1 includes a first user device 20, a second user device 22, an authentication system 24 and a remote service server 26. FIG. 1 also shows a user 32, who may use the first and second user devices 20 and 22 to perform an action at the remote service server 26.

In the embodiments described below, the first user device 20 is a desktop computer, the second user device 22 is a smart phone and the authentication system 24 and remote service server 26 are computers. It will be appreciated, however, that the invention may be implemented on many different hardware platforms, and in other embodiments the first user device 20 and/or second user device 22 may be a desktop computer, laptop, notebook, tablet, PDA, mobile phone, land line phone, PBX phone or any other device.

As shown, the first user device 20 and the remote service server 26 are connected to support electronic data communication via first communications channel 28 and the second user device 22 and the authentication system 24 are connected to support electronic data communication via a second communications channel 30. The transfer of data over the first and second communications channels 28 and 30 may involve wired or wireless data communication. Communications networks over which channels 28 and 30 operate may be any type of network, such as a mobile or fixed line telephone network, the internet, a wireless network, a radio frequency network or a private network.

In the online banking embodiment described below, first communications channel 28 and second communications channel 30 are both internet communications channels. In the electronic shopping embodiment described below, first communications channel 28 is an internet communication channel and second communications channel 30 is a mobile phone network communication channel. It will be appreciated, however, that these embodiments could be implemented over different combinations or types of communication channels.

In the below embodiments, the authentication system 24 and remote service server 26 are separate server computers controlled by a remote service. They are connected via a private network 34. It will be appreciated that the authentication system 24 and remote service server 26 could alternatively be hosted on a single server computer, or the authentication system 24 could be hosted by a separate third party, independent of the remote service.

Further, in these embodiments, the first user device 20 and second user device 22 are able to directly electronically communicate with each other via communications network 36. However, in other embodiments, the two user devices may not be able to electronically communicate.

### Example of an Authentication System

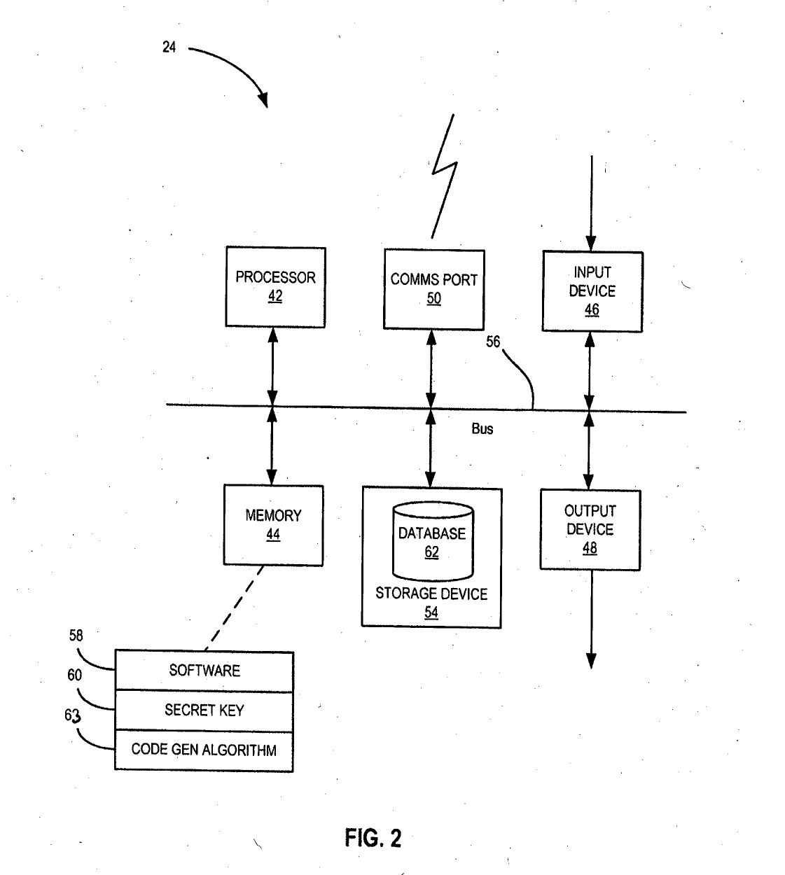

FIG. 2 shows a block diagram of an authentication system 24 according to an embodiment of the present invention. The authentication system 24 includes a processor 42, a memory 44, at least one input device 46, at least one output device 48, a communications port 50 and a storage device 54. As is shown, the components of the authentication system 24 are coupled via a bus or group of buses 56, such as data, address and/or control buses.

The processor 42 may include more than one processing device, for example to handle different functions within the authentication system 24. The memory 44 and storage device 54 may include any suitable memory device including, for example, volatile or non-volatile memory, solid state storage devices, magnetic devices, etc. The memory 44 stores computer software 58 for execution by the processor 42 for performing methods as described below.

In this embodiment, the memory 44 also stores at least one shared secret key 60. Multiple secret keys may be stored in the memory 44, or in a database 62 stored in the storage device 54, each secret key associated with a different user identifier. For example, if the authentication system 24 is for a financial institution, each secret key 60 may be associated with a particular account, or account holder. Alternatively, the secret key 60 may be stored externally of the authentication system 24 and may be accessible to the authentication system 24 via a communications network. The secret key 60 in this example is a 256-bit binary code.

The memory 44 also stores a code generation algorithm 63 for generating a one time password based on the secret key 60. Further details of this algorithm and the secret key will be given below.

Example input devices 46 include a keyboard, a mouse or other pointer device, a trackball, joystick or touch-screen, a microphone, a data receiver or antenna such as a modem or wireless data adaptor, data acquisition card, etc. Example output devices 48 include a display device, a set of audio speakers, a printer, a port (for example a USB port), a peripheral component adaptor, a data transmitter or antenna such as a modem or wireless network adaptor, etc.

The communications port 50 allows the authentication system 24 to communicate with other devices via a hard wired or wireless network, such as networks 30 and 34. Suitable communications ports may use an IEEE802.11 based wireless interface, a general packet radio service (GPRS) compatible interface, a wireless application protocol (WAP) compatible interface, a Bluetooth interface, an optical interface (such as an IrDA interface), a ZigBee interface, a universal serial bus (USB) interface or the like, an Ethernet (IEEE802.3) wired interface or an radio frequency identification (RFID) induction based communication interface.

The authentication system 24 may be any form of terminal, server processing system, specialised hardware, computer, computer system or computerised device, personal computer (PC), mobile or cellular telephone, mobile data terminal, portable computer, Personal Digital Assistant (PDA), pager, smart card or any other type of device.

The remote service server 26, first user device and/or second user device may also have components as described above in relation to the authentication system 24. The remote service server 26 and authentication system 24 may alternatively be hosted on a single computer.

### Example of a User Device

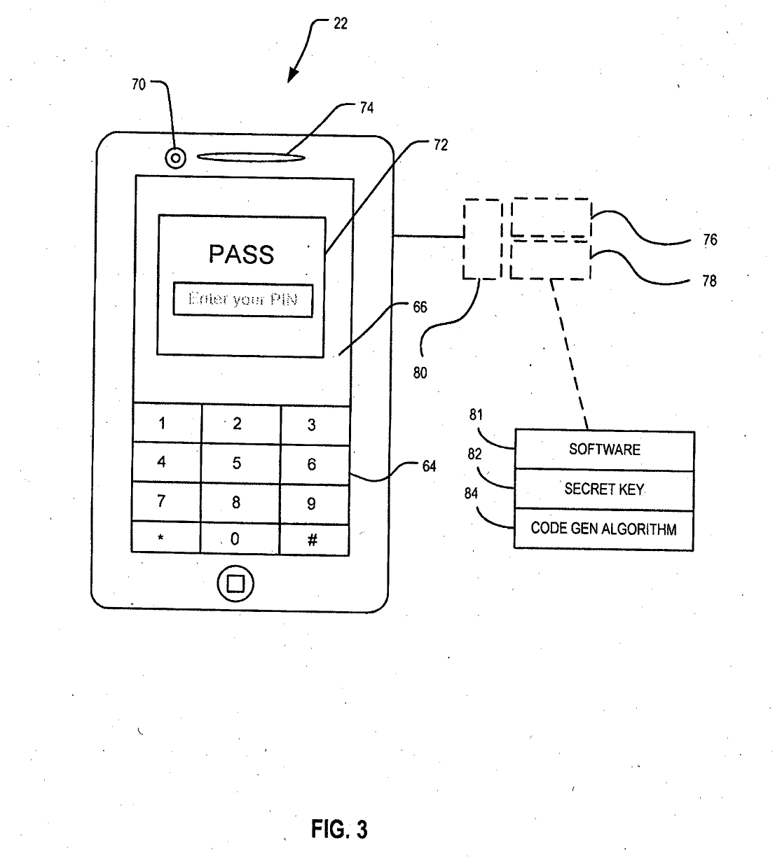

FIG. 3 shows a schematic diagram of a second user device 22 according to an embodiment of the present invention. As described above, in this example the second user device 22 is a smart phone. The second user device 22 includes inputs in the form of a keypad 64, a touch screen 66, a microphone (not shown) and a camera 70. The second user device 22 also includes outputs in the form of a display 72, a speaker 74, and a haptic vibration device (not shown). The second user device 22 may further include a biometric sensor, such as a fingerprint scanner.

The second user device 22 internally includes a processor 76, a memory 78 and a power supply 80. The memory 78 of the second user device 22 stores software 81 for performing methods as described below and a secret key 82. The secret key 82 may be for accessing a particular service, such as an electronic data interchange service (for example an on-line banking service, share trading service, an on-line shopping service, or the like), a computer network service (for example a network log-on service), a communications service (for example an email service or a messaging service), a membership based service (for example an on-line forum, a car-rental service, or a health service), a security service (for example a building access service), or the like.

Alternatively, the secret key 82 may allow access to plural different services. In an embodiment, the memory 78 may store multiple secret keys, each for accessing a particular service or services. The user may be required to select a particular service to indicate to the second user device 22 which secret key is to be used.

The secret key 82 may be a seed, code or data sequence, associated with the second user device 22. In this example, the secret key 82 is a 256-bit binary code. The secret key 82 is the same as the secret key 60 stored in the memory 44 of the authentication system 24 for the particular service. A code generation algorithm 84 is also stored in memory 78. This is the same as the algorithm 62 stored at the authentication system 24.

### Example of a Code Generating Algorithm

The code generation algorithm 62 and 84 may include an encoding process which converts the secret key 60, 82 into a code (e.g. a remote service authentication code, a user authentication code or a user verification code). The code generation algorithm may apply a suitable hashing function to the secret key, or possibly to the result of a logic function involving the secret key and other data. A suitable hashing function may include, for example, MD5, SHA-1, SHA-224, SHA-256, SHA-384, or SHA-512. As will be appreciated, a hashing function converts an input, which in this instance is either the secret key or the result of a logic operation involving the secret key and other data, and provides a fixed length hash value output.

Where the code generation algorithm applies a hashing function which takes as the input the result of a logic operation involving the secret key and other data, a suitable logic operation may include, for example, an XOR logic operation. However, it is possible that other logic operations may be used. The other data may be formed by appending data values such as a synchronisation counter value, and/or user entered information such as an identification code (e.g. a PIN), and/or other information. The synchronisation counter value may be a count value which is synchronised between the authentication system and the second user device for generating or updating a new secret key on the authentication system and the second user device after an authentication process.

Method of Verifying that an Action is Authorised

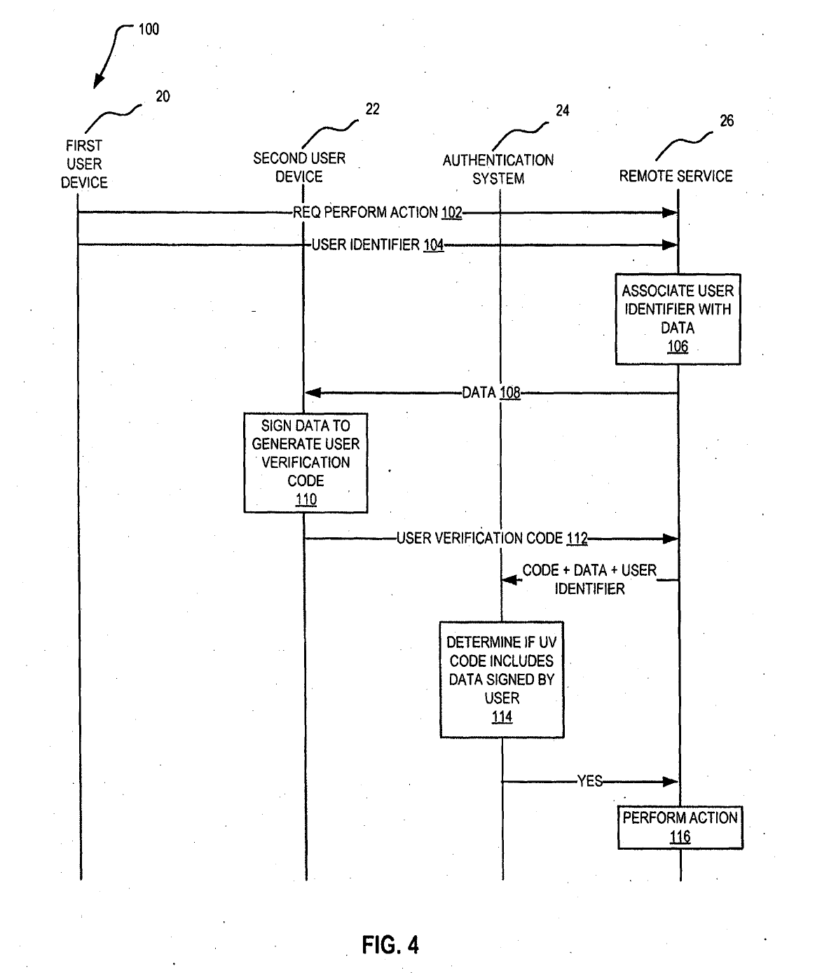

FIG. 4 illustrates generally a method 100 of verifying that an action is authorised by a user 32. At step 102, the first user device 20 communicates a request to the remote service 26 via the first communications channel 28 to perform an action at the remote service 26. At step 104, the first user device 20 communicates a user identifier to the remote service 26 via the first communications channel 28, the user identifier identifying the user. Steps 102 and 104 may take place as part of a same communications transmission. The remote service 26 associates the user identifier with data relating to the requested action at step 106. At step 108, the remote service 26 communicates the data to the second user device 22 via the second communications channel 30. At step 110, the second user device 22 executes the code generation algorithm 84 to digitally sign the data, thereby generating a user verification code, the code generation algorithm 84 being based on the secret key 82. At step 112, the second user device 22 communicates the generated user verification code to the remote service 26. At step 114, the remote service uses the authentication system 24 to determine if the user verification code includes the data, digitally signed using the code generation algorithm 62 based on the secret key 60 associated with the user identifier. If the determination returns positive, then the remote service 26 takes this as a verification that the action is authorised by the user, and then performs the requested action at step 116.

Example of Verifying that a User is Authorised to Log into an Online Bank Account

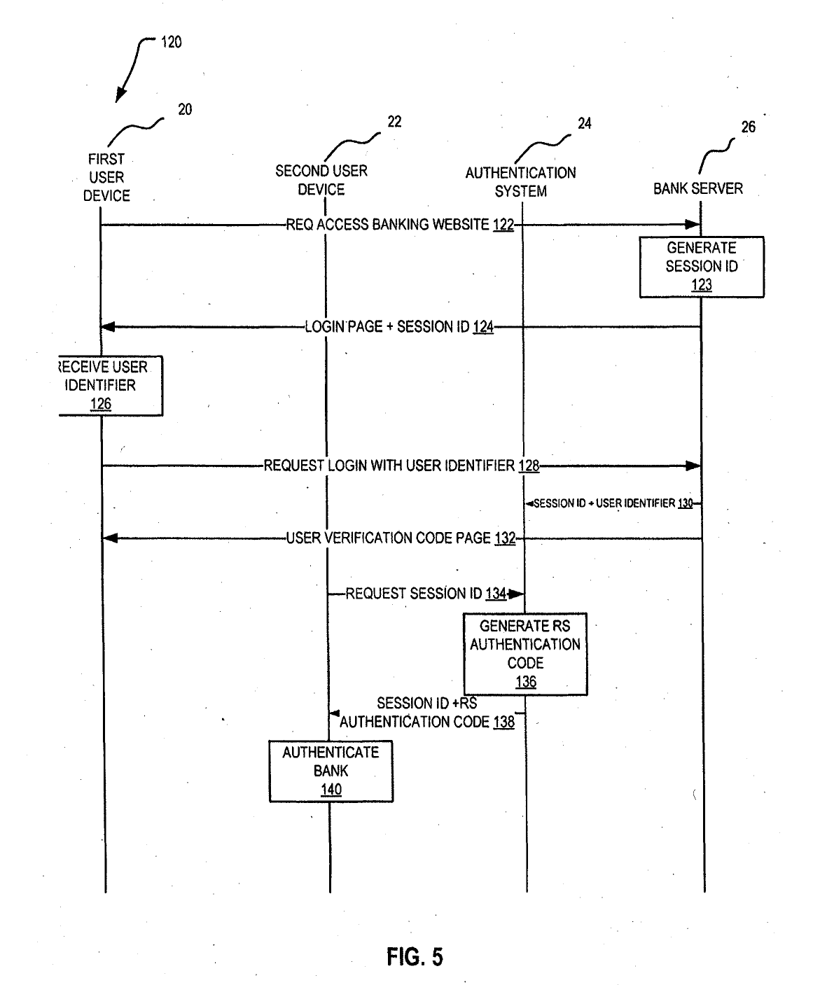

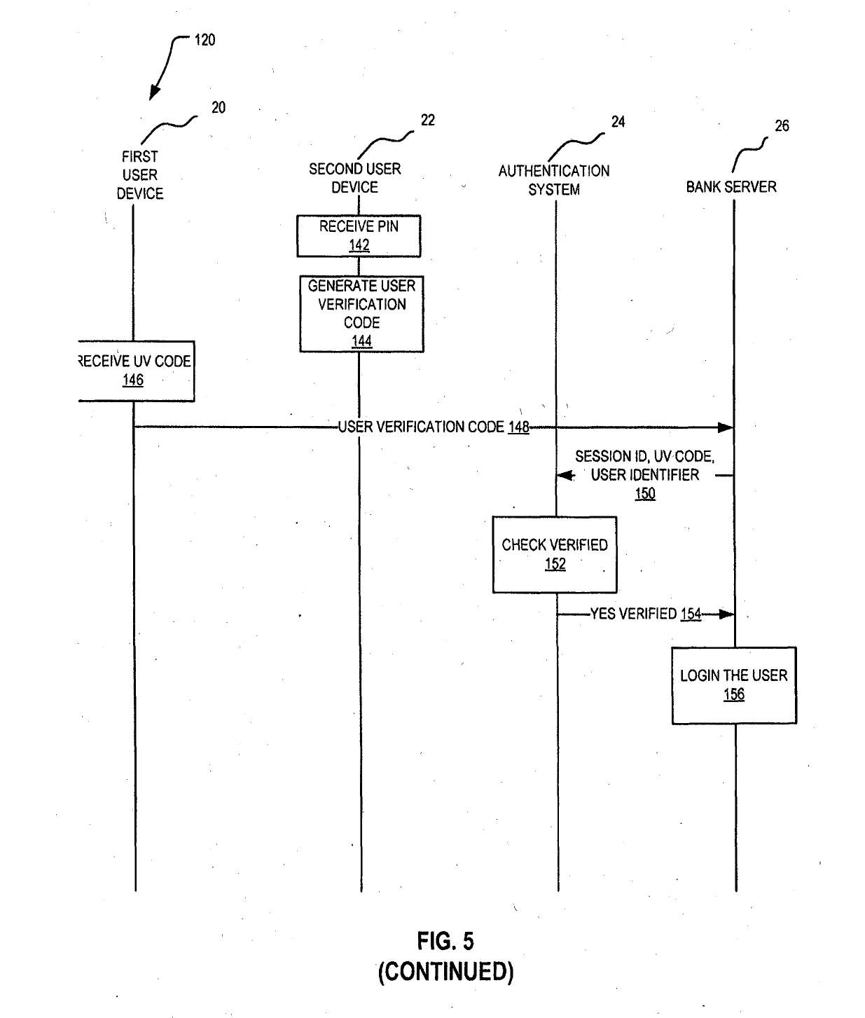

A specific embodiment of a method 120 of verifying that a user 32 attempting to log into an online bank account at a bank server 26 is authorised to log in will be described with reference to FIG. 5.

At step 122 the user 32 uses a web browser on the first user device 20, for example the user's desktop computer, to access an online banking website (including a bank server) 26 via the first communications channel 28 on the internet. The bank server 26 creates a random session identifier to track the user 32 at step 123 and communicates the session identifier to the first user device 20, together with a login page at step 124. The session identifier in this example is stored in a cookie in the user's browser.

At step 126 the user enters their online banking user identifier (for example a 6-10 digit account number) into the login page displayed in their browser and clicks submit. At step 128 the first user device 20 communicates a request to the bank server 26 via the first communications channel 28 to log into the online banking website using the entered user identifier.

The bank server 26 communicates the user identifier and session identifier to the authentication system 24 at step 130. At step 132, the bank server 26 returns a webpage to the first user device 20 via the first communications channel 28, the webpage asking the user 32 to enter a user verification code.

To obtain a user verification code, the user 32 starts an application on their smart phone 22. At step 134 the application communicates a request to the authentication system 24 on the second communications channel 30 (via the internet) to communicate the session identifier. The request may include the user identifier, their bank account number, the mobile phone number of their smart phone 22 and/or further information about the smart phone, such as handset type, IMEI and IMSI number, handset serial number, location or other metadata.

The authentication system 24 receives the request and uses the code generation algorithm 62 stored in memory 44 to generate a remote service authentication code at step 136. The code generation algorithm 62 (as described above) is based on the shared secret key 60 associated with the user 32. At step 138, the authentication system 24 communicates the remote service authentication code and the session identifier to the second user device 22 on the second communications channel 30.

At step 140, the smart phone 22 determines whether the remote service authentication code authenticates the bank server 26. This is done by using the code generation algorithm 84 stored in memory 78 on the smart phone 22, based on the shared secret key 82. If an expected code generated using the algorithm 84 correlates correctly with the remote service authentication code, this indicates that the bank server 26 is authentic.

If the code authenticates the bank, the application on the smart phone 22 displays a screen to the user 32, such as shown in FIG. 3, indicating that the code was valid, and requesting the user 32 to enter their PIN. If the code does not authenticate the bank, the application on the smart phone 22 displays a message telling the user 32 that the bank cannot be authenticated, and will not allow the user 32 to continue.

If the bank is authenticated, the user enters their PIN at step 142 using the keypad 64 of the smart phone 22. The smart phone 22 uses the code generation algorithm 84 based on the shared secret key 82, the PIN and the received session identifier to generate a user verification code. The session identifier is thus digitally signed at step 144.

At step 146, the user enters the user verification code into the webpage on the first user device 20. Alternatively, the user verification code may be transmitted from the second user device to the first user device, electronically, for example via a Bluetooth or other wireless connection. The user then clicks submit to communicate the user verification code from the first user device 20 to the bank server 26 via the first communications channel 28 at step 148. At step 150, the bank server 26 communicates the session identifier, the user verification code and the user identifier to the authentication system 24.

The authentication system 24 then determines whether the user verification code includes the digitally signed session identifier at step 152. This is done by using the code generation algorithm 62 stored in memory 44 at the authentication system 24, based on the shared secret key 60, a PIN associated with the user identifier and the session identifier. If an expected code generated using the algorithm 62 correlates correctly with the user verification code, this indicates that the log in request is authorised by the user. It also indicates that the user is authentic, as only the user should have access to the shared secret key and should know the PIN.

The authentication system 24 may also determine a risk score for the user identifier based on the information received from the second user device 22. The decision to authenticate or not authenticate the user 32 may be based on the risk score, or alternatively the risk score may be an additional piece of data that can be used by the bank server 26 in transactions with the user 32.

If the user verification code includes the signed session identifier and authenticates the user, at step 154, the authentication system 24 communicates the verification to the bank server 26. Otherwise, the authentication system 24 communicates to the bank server 26 that the log in is not approved and the user is not authenticated. The authentication system 24 may also communicate the risk score to the bank server 26.

If a positive verification and authentication has been received, the bank server 26 allows the user 32 to login and access their online banking at step 156. Otherwise, the user 32 is denied access.

As an alternative to the user verification code being used to authenticate the user, a user authentication code may be generated by the second user device 22 and communicated to the authentication system 24 to authenticate the user. For example, the user authentication code may be communicated with the request at step 134 for the session identifier. Alternatively, the user authentication code may be communicated after the second user device 26 has authenticated the bank at step 140. These alternatives provide the option of the session identifier being communicated from the authentication system 24 to the second user device 22 only after the user has been authenticated.

It will be appreciated that the ordering of steps in the process may be changed and still achieve the benefits described above.

Example of Verifying that an Online Purchase is Authorised

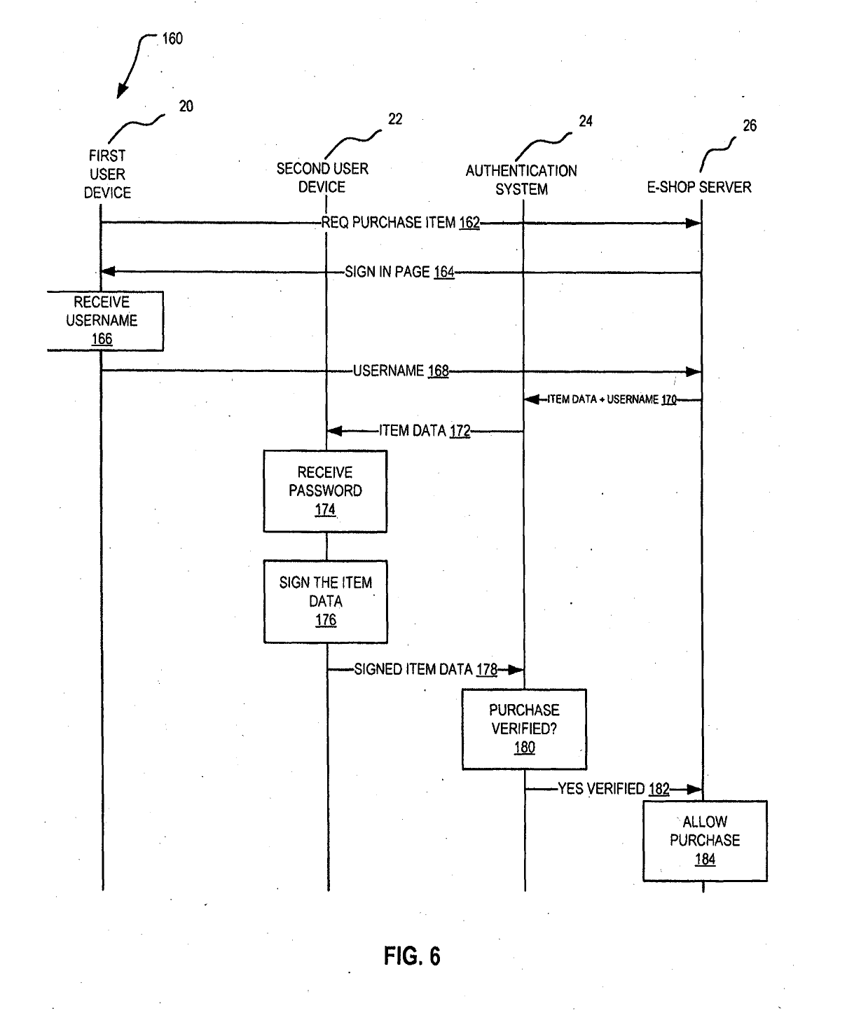

A specific embodiment of a method 160 of verifying that a purchase of items online is authorised will be described with reference to FIG. 6.

The user 32 uses a web browser on the first user device 20, in this example the user's desktop computer, to access a website of the retail server 26 such as an e-shop server and select one or more items for purchase, such as a pair of brand X black shoes costing $100. At step 162, the user 32 clicks on a “purchase” button on the website, causing the first user device 20 to communicate a request to purchase the selected items to the retail server 26 via the first communications channel 28.

At step 164, the retail server 26 communicates to the first user device 20 a sign in page, asking them to enter their username. At step 166 the user enters their username into the sign in page displayed in their browser and clicks submit. At step 168 the first user device 20 communicates the username to the retail server 26 via the first communications channel 28.

The retail server 26 then communicates the username and information about the selected items (for example “brand X black shoes—$100”) to the authentication system 24 at step 170.

At step 172, the authentication system 24 communicates the information about the selected items to the second user device (smart phone) 22 via the second communications channel 30, which in this example is a mobile phone network communications channel.

The receipt of the communication causes an application to be started on the smart phone 22, which displays the information for the user to check. For example, if the information is “brand X black shoes —$100” the user may be shown a message such as “You have requested a purchase of brand X black shoes—$100, please enter your password to confirm this purchase.”

The user enters their password using the keypad 64 of the smart phone 22, which is received into the smart phone 22 at step 174. The smart phone 22 uses the code generation algorithm 84 based on the shared secret key 82, the password and the item information to generate a user verification code at step 176. The information “brand X black shoes—$100” is thus digitally signed.

At step 178, the smart phone 22 communicates the signed item information to the authentication system 24 via the second communications channel 30.

The authentication system 24 then determines whether the user verification code includes the digitally signed item information at step 180. This is done by using the code generation algorithm 62 stored in memory 44 at the authentication system 24, based on the shared secret key 60, a password associated with the username and the item information. If an expected code generated using the algorithm 62 correlates correctly with the user verification code, this indicates that the purchase is authorised by the user. It also indicates that the user is authentic, as only the user should have access to the shared secret key and should know the password.

If the user verification code includes the signed item information, at step 182, the authentication system 24 communicates to the retail server 26 that the purchase of “brand X black shoes—$100” is authorised by the user 32. The retail server 26 then takes necessary steps to allow the purchase to go ahead at step 184. Otherwise, the authentication system 24 communicates to the retail server 26 that the transaction is not approved and the purchase is denied.

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by the skilled person.

1. A method of verifying that an action is authorised by a user, including:
receiving a request from a first user device to a remote service via a first communications channel to perform an action at the remote service,
receiving a user identifier from the first user device via the first communications channel, the user identifier identifying the user,
associating the user identifier with data relating to the requested action,
communicating the data to a second user device associated with the same user identifier via a second communications channel,
receiving a user verification code associated with the user identifier, and
determining if the user verification code includes the data, which is digitally signed using a code generation algorithm based on at least a key associated with the user identifier, the digitally signed data verifying that the action is authorised by the user.

2. A method according to claim 1, wherein the data relating to the action includes a session identifier associated with an application on the first user device used to request performance of the action.

3. A method according to claim 1, wherein the data relating to the action includes information about the action.

4. A method according to claim 1, wherein the action relates to a purchase of one or more items and the data relating to the action includes information about the one or more items.

5. A method according to claim 1, wherein the code generation algorithm for digitally signing the data is based on user entered information as well as the key associated with the user identifier.

6. A method according to claim 1, further including:
associating the user identifier with additional data relating to the action,
communicating the additional data to the second user device via the second communications channel,
receiving an additional user verification code associated with the user identifier, and
determining if the additional user verification code includes the additional data, digitally signed using at least the key associated with the user identifier.

7. A method according to claim 1, wherein the user verification code associated with the user identifier is received from the first user device via the first communications channel.

8. A method according to claim 7, further including:
the remote service receiving from the first user device the data together with the user verification code,
wherein determining if the user verification code includes the data, digitally signed includes determining if the digitally signed data matches the data received with the user verification code.

9. A method according to claim 1, wherein the user verification code associated with the user identifier is received from the second user device via the second communications channel.

10. A method according to claim 1, wherein the first communications channel is an internet communications channel.

11. A method according to claim 1, wherein the second communications channel is a mobile phone network communications channel.

12. A method according to claim 1, further including:
before the remote service communicates the data to the second user device,
the remote service receiving a request from the second user device via the second communications channel to communicate the data.

13. A method according to claim 12, wherein the request from the second user device includes a user authentication code, further including:
determining whether the user authentication code authenticates the user, and
communicating the data to the second user device only if the user authentication code authenticates the user.

14. A method according to claim 12, wherein the request from the second user device includes information relating to the second user device, further including:
determining a risk score based on the information relating to the second user device.

15. A method according to claim 12, further including
the remote service communicating a remote service authentication code to the second user device via the second communications network, the remote service authentication code enabling the user to authenticate the remote service.

16. A method of a user authorising an action at a remote service, including:
communicating a request from a first user device to a remote service via a first communications channel to perform an action at the remote service,
communicating a user identifier from the first user device to the remote service via the first communications channel, the user identifier identifying the user,
receiving data relating to the requested action at a second user device associated with the same user identifier via a second communications channel,
executing a code generation algorithm on the second user device to digitally sign the data thereby generating a user verification code, the code generation algorithm being based on at least a key associated with the user identifier,
communicating the generated user verification code to the remote service, the user verification code enabling the remote service to verify that the action is authorised by the user.

17. A method according to claim 16, further including:
receiving information entered by the user at the second user device before executing the code generation algorithm,
wherein the code generation algorithm is based on the user entered information as well as the key associated with the user identifier.

18. A method according to claim 16, further including:
before executing the code generation algorithm,
displaying the data on the second user device for the user to check.

19. A method according to claim 16, further including:
after executing the code generation algorithm on the second user device, receiving the user verification code into the first user device, wherein the first user device communicates the generated user verification code to the remote service.

20. A method according to claim 16, wherein the second user device communicates the generated user verification code to the remote service.

21. A method according to claim 16, wherein the data relating to the action includes a session identifier associated with an application on the first user device used to request performance of the action.

22. A method according to claim 16, wherein the data relating to the action includes information about the action.

23. A method according to claim 16, wherein the action relates to a purchase of one or more items and the data relating to the action includes information about the one or more items.

24. A method according to claim 16, further including:
before receiving data relating to the requested action at the second user device,
the second user device communicating a request to communicate the data to the remote service via the second communications channel.

25. A method according to claim 24, wherein the request from the second user device to the remote service includes a user authentication code, the user authentication code enabling the remote service to authenticate the user.

26. A method according to claim 24, wherein the request from the second user device to the remote service includes information relating to the second user device.

27. A method according to claim 16, further including:
before executing the code generation algorithm,
receiving a remote service authentication code from the remote service,
determining whether the remote service authentication code authenticates the remote service, and
executing the code generation algorithm and communicating the generated user verification code to the remote service only if the remote service authentication code authenticates the remote service.

28. A method according to claim 27, further including:
if the remote service authentication code authenticates the remote service, providing an indication to the user on the second user device.

29. A method of verifying that an action is authorised by a user, including:
receiving a request from a first user device to a remote service via a first communications channel to perform an action at the remote service,
receiving a user identifier from the first user device via the first communications channel, the user identifier identifying the user,
associating the user identifier with data relating to the requested action,
communicating the data to a second user device associated with the same user identifier via a second communications channel,
executing a code generation algorithm on the second user device to digitally sign the data thereby generating a user verification code, the code generation algorithm being based on at least a key associated with the user identifier,
communicating the user verification code to the remote service,
the remote service determining if the user verification code includes the data, which is digitally signed using at least the key associated with the user identifier, the digitally signed data verifying that the action is authorised by the user.

30. (canceled)

31. (canceled)

32. (canceled)

33. A remote service system including:
a communications port,
a processor,
a memory, and
software resident in memory accessible to the processor, the software including a series of instructions executable by the processor to carry out a method of verifying that an action is authorised by a user, including:
receiving a request from a first user device to a remote service via a first communications channel to perform an action at the remote service,
receiving a user identifier from the first user device via the first communications channel, the user identifier identifying the user,
associating the user identifier with data relating to the requested action,
communicating the data to a second user device associated with the same user identifier via a second communications channel,
receiving a user verification code associated with the user identifier, and
determining if the user verification code includes the data, which is digitally signed using a code generation algorithm based on at least a key associated with the user identifier, the digitally signed data verifying that the action is authorised by the user.
